(19) United States
(12) Patent Application Publication
(10) Pub. No.: US 2023/0169520 A1
(43) Pub. Date: Jun. 1, 2023

(54) SYSTEM AND METHOD FOR VERIFYING CONSUMER ITEMS

(71) Applicant: Grailed, Inc., New York, NY (US)

(72) Inventors: Julian Connor, New York, NY (US); Jose Miguel Rosello, Brooklyn, NY (US); Julson Lim, Astoria, NY (US); Adebia Ntoso, New York, NY (US); Samuel Barback, Los Angeles, CA (US); Wyatt James Yoss, Colorado Springs, CO (US); Kylie Yi Gao, Brooklyn, NY (US); Arun Gupta, New York, NY (US)

(73) Assignee: Grailed, Inc., New York, NY (US)

(21) Appl. No.: 17/688,207

(22) Filed: Mar. 7, 2022

Related U.S. Application Data
(60) Provisional application No. 63/283,611, filed on Nov. 29, 2021.

(51) Int. Cl. G06Q 30/00; G06Q 30/06

(52) U.S. Cl. CPC G06Q 30/0185; G06Q 30/0641

(57) ABSTRACT

A computer platform is provided that permits selling users to list items for sale and to allow a number of experts to review and verify authenticity of these items. In some embodiments, the system may be capable of queuing items to be listed within a management system, and experts are permitted to review particular items. Also, it is appreciated that certain experts have particular expertise to evaluate items of certain types, and therefore, in some implementations, the system is configured to more accurately match experts with particular items to be reviewed.

### RELATED APPLICATIONS

This application is a Non-Provisional of Provisional (35 USC 119(e)) of U.S. Application Ser. No. 63/283,611 filed Nov. 29, 2021, entitled “SYSTEM AND METHOD FOR VERIFYING CONSUMER ITEMS”. The entire contents of this application is incorporated herein by reference by its entirety.

### BACKGROUND

In the e-commerce area, there are many websites and applications that permit people (e.g., users) to buy and sell items within a marketplace. In some cases, these items may have significant value, and there may be issues with counterfeit items.

### SUMMARY OF INVENTION

It is appreciated that the integrity of an online marketplace suffers when counterfeit items enter the marketplace and they are not detected. In particular, if a marketplace has such problems, a reduction in the amount of users and items sold can affect business. Various marketplaces use people such as experts to determine whether a particular item is genuine, however, it is appreciated that these experts are not perfect. According to some embodiments defined herein, systems and methods are provided that are used to more accurately verify consumer items.

In some aspects, a computer platform is provided that permits selling users to list items for sale and to allow a number of experts to review and verify authenticity of these items. In some embodiments, the system may be capable of queuing items to be listed within a management system, and experts are permitted to review particular items. Also, it is appreciated that certain experts have particular expertise to evaluate items of certain types, and therefore, in some implementations, the system is configured to more accurately match experts with particular items to be reviewed.

Further, it is appreciated that experts can be more accurate in their identifications with the assistance of computer-based tools. In some embodiments, a system is provided that records and tracks counterfeit items as they are submitted to the system, and provides information regarding these items (e.g., photos, notes, etc.) to experts for verifying items submitted in the future. In some embodiments, the system includes and maintains a submitted item database that includes items identified as counterfeit. In some implementations, the system maintains a database of items that are definitively verified as being genuine. By tracking these items and providing previously-submitted item information to experts, these experts may be provided a computer interface through which a subject item may be compared.

Further, it is appreciated that in some marketplaces, there may be thousands or even millions of items that are submitted, and because of this, it may be unacceptable for a significant delay for an item to be listed due to performing verification steps. In some embodiments, an efficient hierarchical review process is provided that allows experts to more efficiently verify the authenticity of items. These may be architected to make the review process more timely. In some embodiments, machine learning or other artificial intelligence tools may be used to classify items as being at risk of being counterfeit.

According to one aspect, a system is provided. In some embodiments, the system comprises an interface component configured to receive a plurality of item listings from one or more users, each of the item listings corresponding to an item submitted by a respective user for sale in an electronic marketplace, a queue of submitted items for sale, a component that is adapted to assign at least one of the submitted items for sale to the queue of the submitted items for sale, and a computer interface configured to permit an expert to view associated data submitted by the respective user for the item and to update a verification status of the item.

According to one embodiment, the expert is permitted to select the item submitted by the respective user from the queue of the submitted items for sale. According to one embodiment, the system is configured to assign a review status of the item to the expert and remove the item from the queue. According to one embodiment, a component that is configured to determine a matching of at least one of the submitted items for sale to the expert. According to one embodiment, a component that is configured to determine a matching of the item to be verified with a second one of the plurality of experts, and conducting a second review of the item to be verified.

According to one embodiment, the system further comprises a database of items that have been previously identified as being genuine. According to one embodiment, the system further comprises a database of items that have been previously identified as being counterfeit. According to one embodiment, the computer interface further comprises a viewer configured to view images of item to be verified as being genuine with at least one of a plurality of experts. According to one embodiment, the system further comprises a component configured to determine, from a plurality of images of the item to be verified, a match score with a plurality of images associated with the database of items that have been previously identified as being genuine.

According to one embodiment, the system further comprises a component configured to determine, from a plurality of images of the item to be verified, a match score with a plurality of images associated with the database of items that have been previously identified as being counterfeit. According to one embodiment, the system further comprises a component configured to determine a risk measure for the submitted item.

According to one embodiment, the risk measure is determined based on a designer identification of the submitted item. According to one embodiment, the risk measure is determined based on a category of the submitted item. According to one embodiment, the risk measure is determined based on user criteria of the respective user that submitted the item. According to one embodiment, the risk measure is determined at least in part by a component configured to determine, from a plurality of images of the item to be verified, a verification status of the plurality of images with a plurality of images associated with the database of items that have been previously verified.

According to one embodiment, the verification status is at least one of a group comprises a status indication that the submitted item is genuine, and a status indication that the submitted item is counterfeit. According to one embodiment, the risk measure is a relative risk measure in relation to another item or groups of items. According to one embodiment, the risk measure includes a risk score. According to one embodiment, the user criteria includes information identifying a user that has previously submitted counterfeit items. According to one embodiment, the user criteria includes information identifying a user is a trusted user. According to one embodiment, the system further comprises a user interface through which the respective user can submit a listing for the item for sale in the electronic marketplace. According to one embodiment, the user interface includes at least one control to submit one or more photos of the item for sale.

According to one embodiment, the system further comprises a component that determines, for a product category of the item, a set of photos required for the product category. According to one embodiment, the system further comprises a machine learning engine adapted to determine a risk measure for the item submitted by the respective user. According to one embodiment, the machine learning engine is trained using at least one set of a group of data sets comprises a data set of items that have been previously identified as being genuine, and a data set of items that have been previously identified as being counterfeit. According to one embodiment, the machine learning engine is trained using at least one set of a group of data sets comprising a designer identification of the submitted item.

According to one embodiment, the machine learning engine is trained using at least one set of a group of data sets comprising a category of the submitted item. According to one embodiment, the machine learning engine is trained using at least one set of a group of data sets comprising user criteria of the respective user that submitted the item. According to one embodiment, the system further comprises a data set of previously submitted items to which the submitted item is compared. According to one embodiment, the data set of previously submitted items include a record of a previously-submitted item comprising a plurality of parameters and a set of one or more identifying images of the previously-submitted item. According to one embodiment, the set of one or more identifying images of the previously submitted item comprises at least one of a group comprises a picture of a brand tag of the item, a picture of a care tag of the item, a picture of a Certilogo tag of the item, and one or more pictures of the item from one or more perspectives.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one embodiment are discussed herein with reference to the accompanying figures, which are not intended to be drawn to scale. The figures are included to provide illustration and a further understanding of the various aspects and embodiments and are incorporated in and constitute a part of this specification but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 shows a block diagram of a distributed computer system 100 capable of implementing various embodiments;

FIG. 2 shows a process for assigning received items to a queue according to some embodiments;

FIG. 3 shows a process for processing submitted items by a hierarchy of experts within a distributed system according to some embodiments;

FIG. 4 shows a process for processing a submitted item within an interface according to some embodiments;

FIG. 5 show a process for processing multiple queues by a supervisor expert according to some embodiments;

FIG. 6 show example queue structures according to some embodiments;

FIGS. 7A-7B show an example user interface for submitting items in accordance with some embodiments;

FIGS. 8A-8B show example management user interfaces used to manage submitted items in accordance with some embodiments; and

FIG. 9 shows an example machine learning system capable of analyzing submitted items according to various embodiments.

### DETAILED DESCRIPTION

As discussed above, in some aspects described herein, a computer platform is provided that permits selling users to list items for sale and to allow a number of experts to review and verify authenticity of these items. In some embodiments, the system may be capable of queuing items to be listed within a management system, and experts are permitted to review particular items.

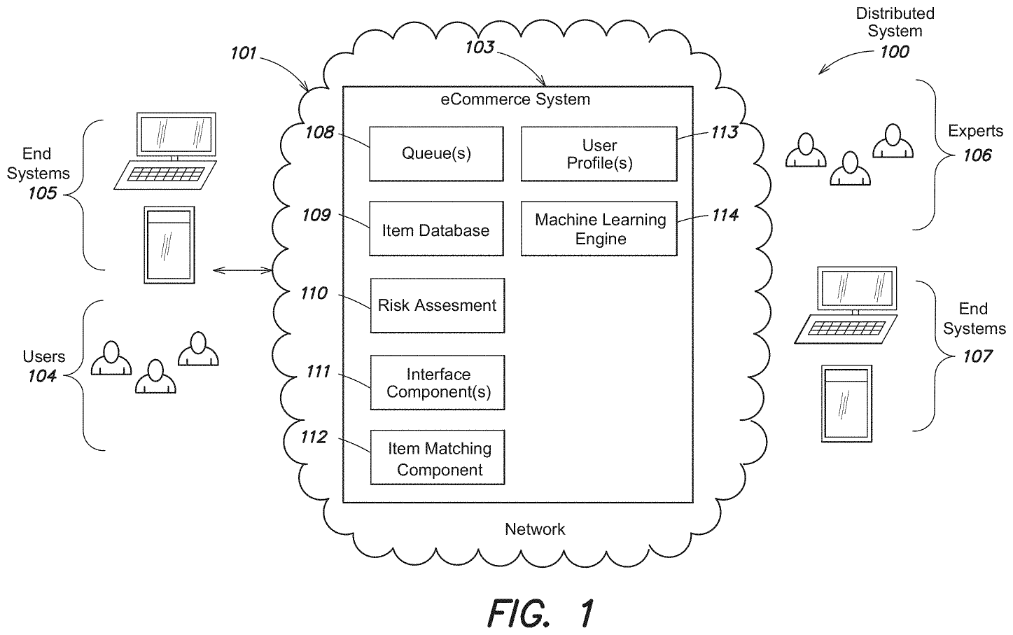

FIG. 1 shows a block diagram of a distributed computer system 100 capable of implementing various embodiments. In particular, an ecommerce computer system may be provided that creates an online marketplace among a number of users (e.g., users 104). Such users look to sell certain items within the marketplace, and using one or more end systems (e.g., end systems 105), such users can create a listing of an item for sale within the marketplace. Once an item is listed, it is available for other users to view and purchase.

However, in some embodiments, to maintain the integrity of the ecommerce environment, it may be desired to perform one or more verification steps prior to an item being available for purchase. Because of the number of possible items being listed and sold, it is appreciated that a management system that efficiently vets items among a number of experts would be beneficial. In some embodiments, multiple experts (e.g., 106) access the ecommerce system through one or more end systems (e.g., end systems 107) for the purpose of verifying authenticity of submitted items in an accurate and expedient manner.

To this end, the ecommerce system includes one or more queues (e.g., queue(s) 108) to which submitted items may be tracked and worked by experts. There may be numerous queues, through which an item may be advanced in the review process. These queues may be arranged in a hierarchy to permit experts to work asynchronously and therefore, more efficiently. In some embodiments, these queues may be FIFO queues that require experts to process items in a first-in, first-out manner. Further, in some embodiments, there may be management components that track an amount of time that an item is pending prior to verification and may adjust a priority status of an item based on this measurement.

In some embodiments, the queues may be viewable within the user interface by a reviewing user. For example, a user may be permitted to select a control within the interface that displays medium risk queues that are viewable by that particular user. Similarly, the user may be permitted to see any other type of queue that may be created by the system. Such queues may be created using filters that permit the system to create a certain view. Certain filters may be selectable within the interface.

Further, ecommerce system 103 may include one or more item databases (e.g., database 109). These may be the same or different databases and may be any type or format. In some embodiments, the ecommerce system maintains multiple databases, and may use such databases for experts and/or assisting tools for classifying submitted items. For instance, the system may maintain a database of submitted items that have been identified as counterfeit. This item database may include information (e.g., photos, description, item type, etc.) that may be used by an expert or one or more tools to compare to submitted item so that a verification status may be determined.

System 103 may also include a risk assessment component 110 that is configured to determine risk of a submitted item being counterfeit. Component 110 may determine a risk measure based on one or more parameters, including inputs from the submitting user, information submitted regarding the item (e.g., type of item, brand of item, photo information, etc.). Such information may be used to determine a risk measure for the item. In some embodiments, risk rules may be provided that determine which items are more risky than others, and they may be based on one or more parameters. Also, unique item characteristics related to the submitted item may be compared to reference item characteristics with the database. Further, the risk measure may also be determined based on information submitted by one or more experts or other tools (e.g., a machine learning component).

System 103 may also include one or more interface components (e.g., interface component(s) 111) that may be used to interface users with system 103. For example, such interfaces may include web-based interfaces, distributed apps, or other type of computer interface (e.g., an Application Program Interface (API)). One or more components of system 103 may be configured as stand-alone services and may be located or executed in various locations within a distributed network.

System 103 may also include an item matching component (e.g., item matching component 112) that is configured to determine matches between submitted items and the experts that are best-positioned to validate those items. For instance, an expert may be an expert in validating a particular brand of sneakers (e.g., Nike) and therefore, the matching component may be configured to route those types of items to a particular reviewer. The matching aspect may be performed, for example, by applying filters within the interface to show (or not show) certain items. This filtering action may be, for example, by the expert selecting (e.g., within the interface) appropriate filters based on their expertise. In some embodiments, the system may learn or apply new filters based on ML or other approaches (e.g., rules).

The matching component may also move items into queues based on characteristics of the items (e.g., brand, type of item, etc.). The matching component may also include filters that allocate certain items to expert users having appropriate training, specialization, performance or other indicators. Further, in some embodiments, listing in question may be sent to more experienced experts (e.g., authenticators) for second level, third level, etc. review. In some embodiments, the system automatically routes submitted items to appropriate queues, where the proper experts can process the submitted items.

System 103 may also include one or more user profiles associated with submitting users and/or expert users. Notably, a historical tracking of submitted items from particular users may be used to determine a risk measure for an item submitted from that user. For instance, if the user commonly submits counterfeit sneakers, a risk measure for a newly-submitted item that is of a same or similar type may be adjusted (e.g., by placing the item in a high risk category).

System 103 may also include a machine learning engine (e.g., engine 114) or other artificial intelligence (AI) component that assists or performs with one or more of the assessments and/or routing of submitted items. For instance, an AI component may be used to identify one or more features associated with a counterfeit item, and appropriately place that item in a high-risk category or queue. In some embodiments, one or more AI components may be trained to identify features of genuine items as compared with a reference or training database of genuine items. Further, one or more AI components may be trained to identify features of counterfeit items as compared with a reference or training database of counterfeit items.

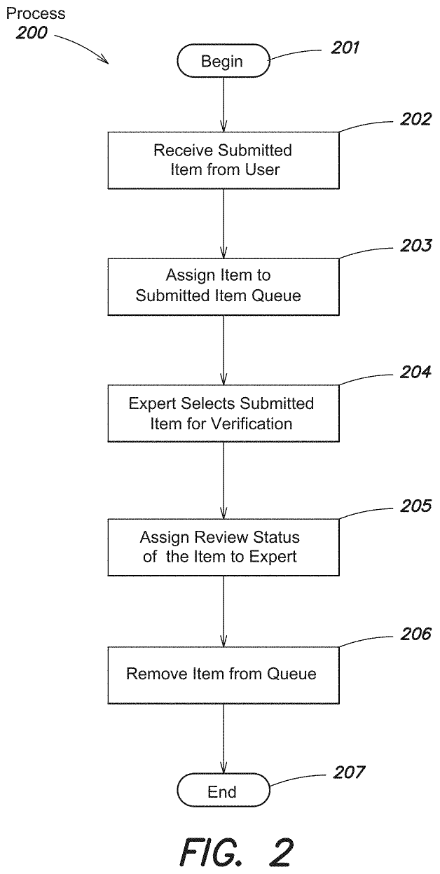

FIG. 2 shows a process 200 for assigning received items to a queue according to some embodiments. At block 201, process 200 begins. At block 202, the system receives a submitted item from the user. For instance, a user may be permitted to log into a browser interface, application, or other software type in order to enter an item to be sold. The user may select or enter in identifying information for the item, along with example photos of the item, along with any identifications (e.g., tags, logos, etc.).

At block 203, the system assigns the submitted item to a submitted item queue. In some embodiments, the submitted item queue is a queue of items yet to be validated. As discussed, in some example implementations, submitted items are not listed until they are validated. In some embodiments discussed below, the system may determine a risk measure associated with the submitted item. Such a risk measure may be used to assist an expert in determining a risk level associated with the submitted item.

At block 204, an expert selects the submitted item for verification. In some instances, an expert may view a filtered list of submitted items based on their area of expertise in validating items. Once selected, the system assigns review status of the item to the expert that selected (e.g., at block 205). Optionally, the system may remove the item from the queue at block 206. In an alternate implementation, the system may merely leave the item in the queue but restrict selection from other experts. At block 207, process 200 ends. After a submitted item has been selected by an expert a process for validating the submitted item by one or more experts can begin.

In some embodiments, the system may perform an “auto publish” rule after some determined time, the item enters the ecosystem. For instance, one rule may include publishing an item that is in the queue longer than a preset time (e.g., in the queue more than 72 hours) and the item is not reviewed, then the item is published to the ecosystem.

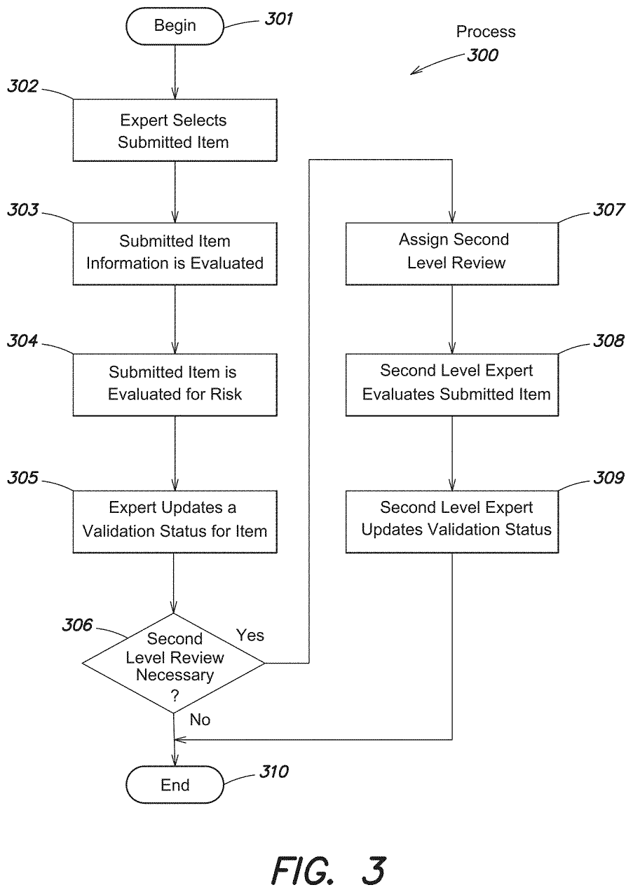

FIG. 3 shows a process 300 for processing submitted items by a hierarchy of experts within a distributed computer system according to some embodiments. At block 301, process 300 begins. At block 302, a reviewer expert selects a submitted item from the submitted item queue. At block 303, information relating to the submitted item is evaluated. For example, a reviewer may view information provided with the submitted item such as photos, descriptions, type information, among others to determine whether the item is genuine. For example, in the case of an article of clothing, the reviewer may view identifiers printed on tags associated with the item and verify that the identifying numbers are the same from a reference database. For instance, a reviewer may consult other e-commerce websites that sell similar items, or the system may provide such information along with items which have been previously verified as being genuine. In the case of a shirt, there may be one or more identifying tags such as a neck tag, a wash tag, or other identifying tags (e.g., a Certilogo Tag), whereby either visual inspection or comparison to authentic examples may be used to determine whether the item is genuine. In the case of a Certilogo Tag, the tag may include a serial number or other identifier that can be validated online.

After viewing and comparing various parts of the submitted item, the submitted item is evaluated for risk at block 304. In some embodiments, the item may be evaluated for risk prior to selection and/or display to the expert user (e.g., at the beginning of process 300). In some embodiments, the risk may include a risk classification and may be displayed to the expert user within the interface.

At block 305, the expert updates the validation status for the item.

As discussed, a risk measure may be determined for a submitted item. The risk measure may be a numerical identifier (e.g., risk between 1-100, 1-10, etc.) or a classification (e.g., high, medium, low) or some other identification type. In some embodiments, the risk measure may be calculated using one or more risk rules. In one implementation, submitted items are assessed for risk based on a database of counterfeit (e.g., fake) and genuine items which informs the system on what items are risky vs not based on unique item characteristics/risk indicators (e.g. designer, category, type of user, etc.). Each listing is allocated a risk measure that depends on the risk indicators for that particular item.

For example, in one implementation, an item can be considered “high risk” if it meets a rule called “high_risk_designer”_listing criteria. For this rule, there may be a definition of a complex rule that identifies:
The listing price >$X
One of the listing's designers is identified as a “high risk” designer (e.g., as provided in a list maintained by the system)
The seller has fewer than X transactions (buys+sales)
   An example of a high-risk designer is Gucci. So, a Gucci item that is over $X listed by a seller who has fewer than X transactions is considered “high risk” and would automatically be sorted into the “high risk” queue (e.g., the queue type high risk radio button). The system may apply one or more of these rules in parallel, and apply them to form certain queues (e.g., a high-risk queue). The system may maintain one or more rules that may be used to determine whether an item should be added to certain queues.

It should be appreciated that one or more of these rules may be used alone or in combination with other rules. In some embodiments, rules may be evaluated independently from other rules in parallel. Such rules may, for example, involve evaluation of one or more parameters in real time, and may be combinations of rules that cause the system to handle items. For example, listing price may be used to determine whether an item is placed in a high or low risk queue (e.g., alone or in addition to other parameters within a rule). In some embodiments, a parameter that tracks certain designers may be used to determine whether an item is determined to be of a certain risk level. Further, there may exceptions that can apply to certain rules that would override a particular queue placement and/or risk level.

In some embodiments, it is appreciated that risk assessment and evaluation of rules may be determined in real time, and therefore the system may continuously or at predetermined intervals or other occurrence may determine a risk level associated with the items. So, for example, an item may enter the system at a particular risk level, but based on changes to rules, risk levels changing for particular items/designers, etc., the risk level for that item may change over time and may cause the item to be reevaluated (e.g., as a result of being placed in a queue). Also, it should be appreciated that an AI component may be used in addition to or in combination to rules to determine whether an item gets placed by the system into one or more queues.

In some embodiments, rules may be used to determine a risk rating and cause the item(s) to be moved to particular queues. Notably, some of these rules may include exceptions and/or other complex rule aspects that would cause a listing to be moved (or not) to another queue. Further, there may be certain users that are determined to be low risk, and the system may exempt items submitted from being transferred to these higher risk queues. However, in some embodiments, risk qualifications for items may be determined in real time, and therefore an item initially determined as a low-risk item may be later determined to be high risk and therefore transferred to a higher risk queue.

In some embodiments, experts are permitted to include additional information in the listing, such as information regarding multiple decisions made during the evaluation which provides a trail of the listing's risk evaluation.

At block 306, the system determines whether a second level review is necessary based at least in part on the validation status and other risk measures determined for the submitted item. If no second level review is necessary, process 300 ends at block 310. It should be appreciated that one or more acts performed in process 300 may be performed in parallel or in other sequences.

However, if a second level review is necessary, the system may perform one or more additional review steps or levels by one or more additional experts. For example, at block 307, the system assigns the second level review to another reviewing expert. In some embodiment, this act may be performed as part of step 305 or 306. For instance, in some embodiments, one of the “validation status” choices is “legit check” which is what assigns the item to a second level of review.

At block 308, the second level expert evaluates the submitted item (e.g., in a similar manner with respect to the first level review). However, the second level expert may have more experience and review capability than the first level expert. At block 309, the second level expert updates the validation status of the submitted item. In some cases, the submitted item may be validated, however the submitted item may remain in a queue such as one for high or medium risk items. There may be additional review levels for the item, and either the item is validated as being genuine, remains suspect, or is rejected as being counterfeit. If validated, the submitted item may be entered into a database of published items that are capable of being sold on the e-commerce system application or site. At block 310, process 300 ends.

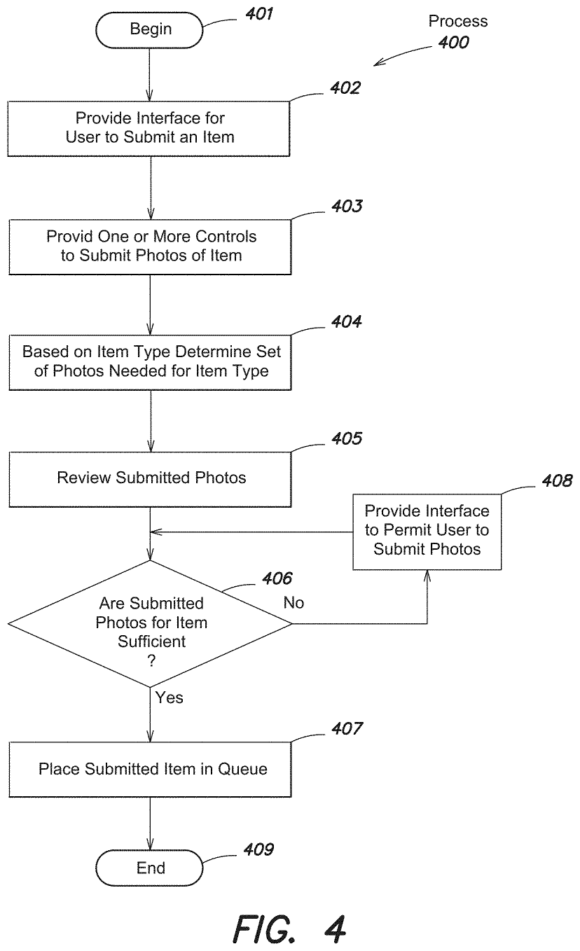

FIG. 4 shows a process 400 for processing a submitted item within an interface according to some embodiments. At block 401, process 400 begins. At block 402, the system provides an interface for a user to submit an item. As discussed, such an interface may be, for example, a browser interface, an application, or other software interface (e.g., an API).

At block 403, the system provides one or more controls to submit photos of the item. Notably, at block 404, depending on the item type, the system determines a set of photos that are needed for that particular item type. For example, in the case of a shirt (possibly based on the brand identifier as well) there may be a certain number of tags, logos, or other portions of the article that may be used to validate the item. The user submits the information related to the submitted item including photos, and at block 405, an assigned expert reviews the submitted photos. In some embodiments, a reviewing user may request that the submitting user submits specific photos of aspects not included in previous submissions.

At block 406, it is determined whether the submitted photos for the item are sufficient for performing the validation. If so, that item is placed within the submitted item queue at block 407. However, if the photos are insufficient, blurry, do not include certain identifying aspects, the reviewing expert may reject the submission and a message may be sent to the submitting user. In some cases, the system may perform certain automated checks (e.g., checks for blurriness, size, other criteria) of the submitted photos prior to placing the item in the submitted items queue. To correct the submission, the system may provide at block 408 an interface to permit the submitting user to submit replacement photos or any additional photos that may have been omitted. If the resubmitted photos are sufficient, the item may be placed within the submitted item queue. At block 409, process 400 ends.

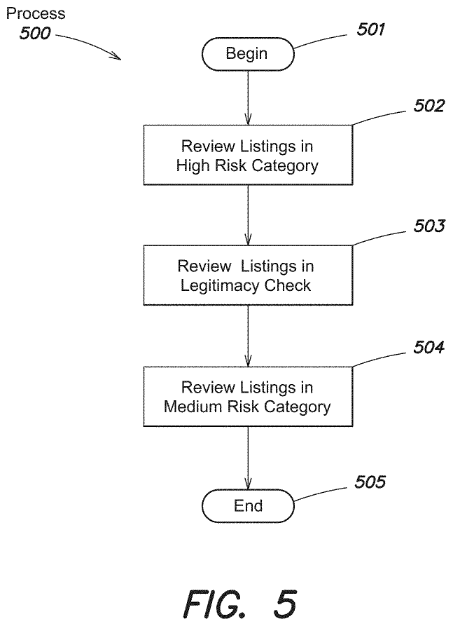

FIG. 5 shows a process 500 for processing multiple queues by a supervisor expert according to some embodiments. At block 501, process 500 begins. According to some embodiments as discussed above, there may be multiple queues or lists of items that are tracked within the system. For example, as expert users take submitted items and perform validation steps, they can be pushed into other categories depending on the information and the expert review provided.

For instance, there may be different classifications according to a risk measure according to some embodiments. In one implementation, there may be high risk, medium risk, and low risk categories in which submitted items may be placed by expert reviewers. These items may also be placed within these categories in a FIFO manner (e.g., in other queues), to ensure that items are processed in an expedient manner.

A second or higher-level supervisor expert may process items from these queues with certain priorities and may process items while reviewing items from multiple parallel queues. For example, at block 502, a supervisor expert may review listings within the high-risk category as a first priority, review listings in a legitimacy check at block 503 as a second priority, and review listings in a medium risk category at block 504. In some embodiments described herein, the legitimacy check is that second level review process that can be performed if the expert does not know the answer and needs a second level review. In some embodiments, the expert chooses, within the interface a “request legit check” control and the item is taken from the medium or high-risk queue to a “legit check” queue. The higher-level expert may operate from these queues in any order, but in some embodiments, items may be pushed to the higher-level expert(s) depending on one or more factors, including, but not limited to, the level of risk, length of time after submission, length of time being in a particular queue and/or other criteria. At block 505, process 500 ends.

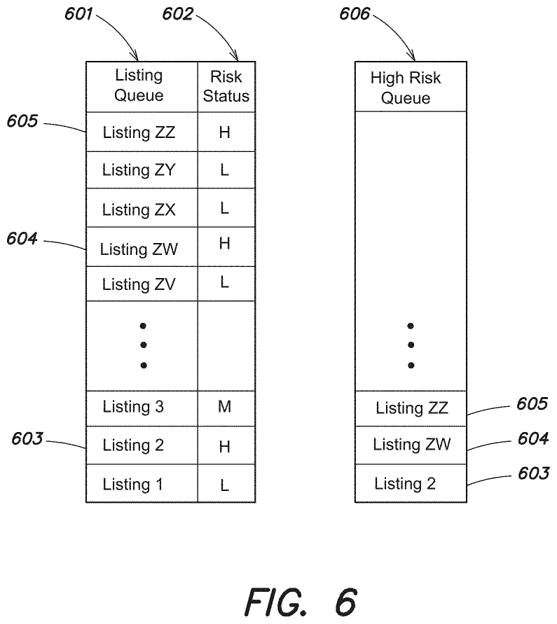

FIG. 6 show example queue structures according to some embodiments. For example, a submitted item queue may include a FIFO listing queue 601 that includes one or more entries associated with one or more items to be listed. These items may be submitted by multiple submitting users from multiple end systems. In some embodiments, the queue may include identifications of a particular risk classification (e.g., risk status 602) for a submitted item. In some embodiments, the submitted items, once classified by a reviewing expert, may be placed in other queues as necessary.

For instance, a high-risk queue 606 may be provided whereby different listings having the same high-risk status may be placed within the high-risk queue. As shown in FIG. 6, items from the submitted item queue indicated as being high risk are then placed within the high-risk queue 606. In the example shown, listings ZZ, ZW, and 2 are placed in the high-risk queue in a FIFO manner. That is, listing 2 maintains its precedence over other listings with a high-risk identification as being submitted prior to those other listings.

There may be, in some embodiments, multiple queues. For example, there may also be a medium risk queue, low risk queue, or other types of queues based on their risk classification. There may be other queues relating to performing workflow operations between experts in the hierarchy. For instance, as discussed above, there may be a queue provided for requesting a legitimacy check (e.g., a legit check queue). So, in one example implementation, an expert user can be permitted to select a control within their user interface that places the item into a legit check queue when the expert user determines that a second level review should be performed. In some implementations, the system may flag certain items automatically (e.g., based on a risk assessment) and may automatically route items to particular queues.

Alternatively or in addition to the processes described above, another component may monitor queue listings for their age and may promote certain listings above others based on their time spent in the validation process.

Example Interfaces

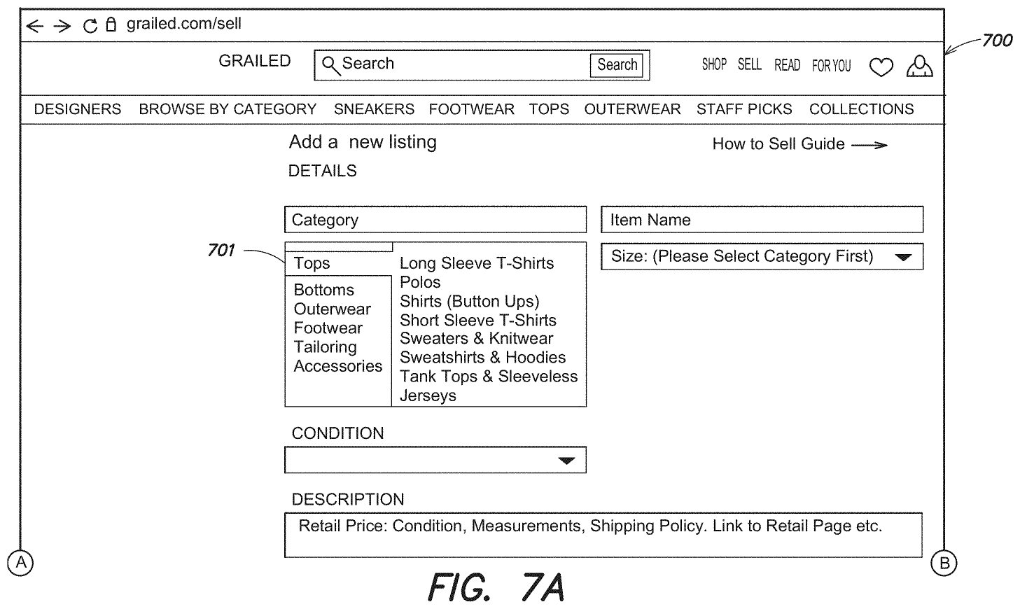

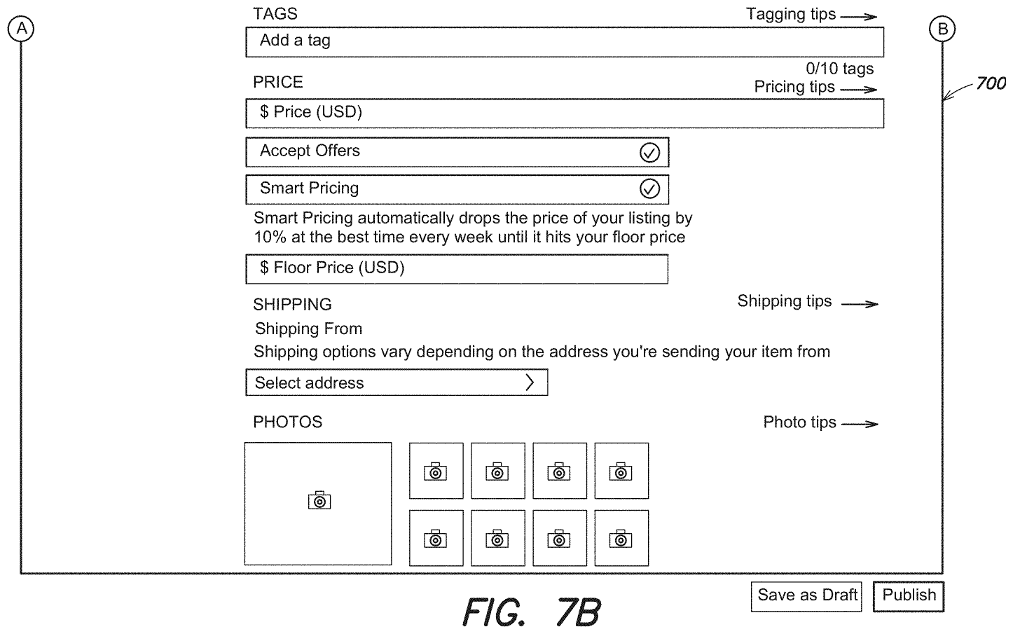

FIGS. 7A-7B show an example user interface 700 for submitting items in accordance with some embodiments. As discussed above, the system may provide an interface through which a user may submit information about the items. For example, as shown in FIG. 7A, an upper portion of the interface may display controls that permit the user (e.g., via an interface control 701) to input information about the item. For example, the system may permit the user to identify a “top” article of clothing such as T-shirts, polos, shirts, short sleeve T-shirts, etc. further, the user may submit condition information, item name information, assigns tags or any descriptions. Further, the system may determine recommended pricing for a particular item based on previous similar items that may have sold within the marketplace and such information may be automatically determined and displayed to the user within the interface. In one embodiment, the system may automatically lower the price of the item based on some function (e.g. 10% each week until it hits a floor price or lower bound price for the item).

Notably, the system permits the user to upload one or more photos that show the item via one or more interface controls. The required photos for a particular item may be determined by the system, and therefore the user interface may change accordingly. For instance, depending on the brand, item type, category or other information, the system may determine the set of required photos for that particular item. In some cases, the system may perform certain automated checks (e.g., checks for blurriness, size, other criteria) of the submitted photos. Once complete, the user may select a control that publishes the item to the system, and in some embodiments, places the item within a submitted item queue to be reviewed by one or more experts. In some example implementations, the system may automatically place the item within a queue to be reviewed by one or more experts (e.g., based on the type of item, risk classification, or other parameter(s), alone or in combination with other parameters). In some implementations, risk level may be evaluated in real-time, and an item may be moved to queues automatically based on their real-time risk classification or other measurement.

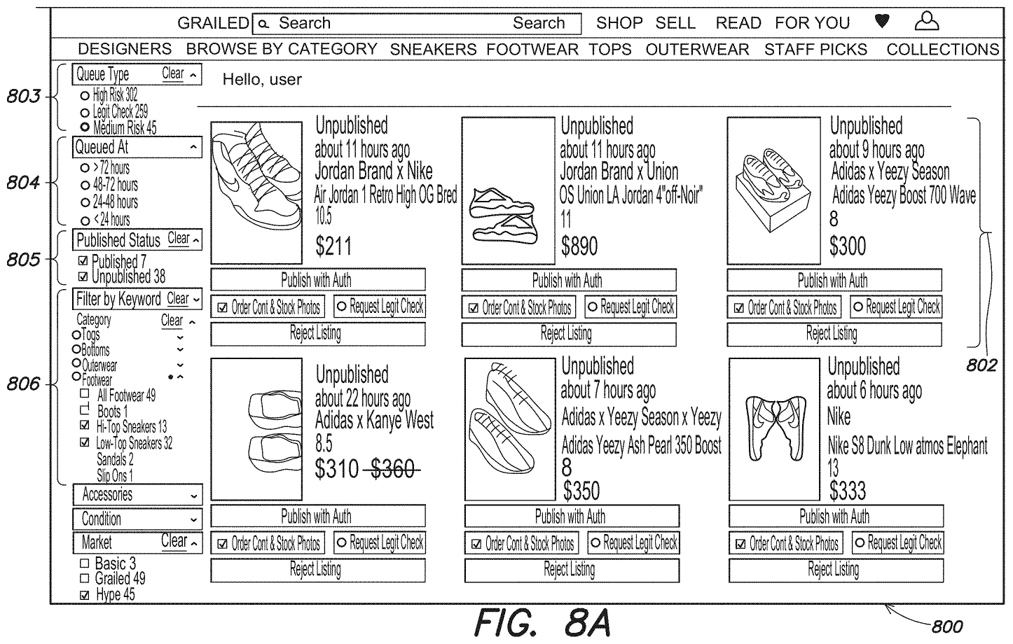

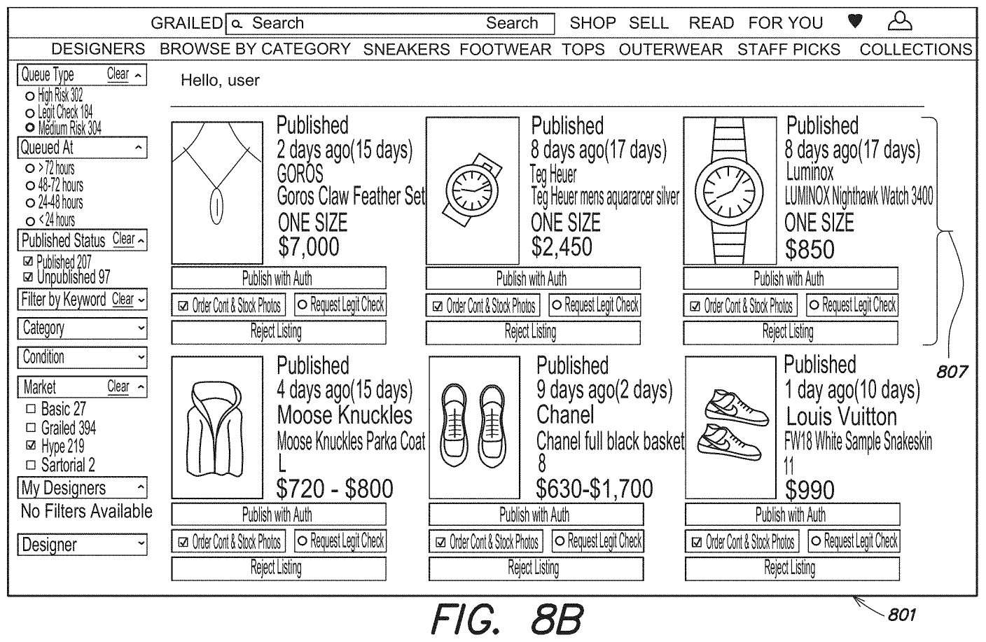

FIGS. 8A-8B show some example management interfaces 800, 801 that might be used by experts to review items that have been submitted to the ecommerce system that forms the marketplace. Notably, a reviewing expert user may be presented one or more interfaces that include controls for permitting them to review items (e.g., unpublished item 802), reject, or publish certain items, request information associated with certain items (e.g., additional photos, specific photos of certain portions or views of the item, etc.), request legitimacy checks, among other operations. Further, in some embodiments, the system may include interfaces having one or more controls that permit the reviewing expert user to filter items based on a number of parameters, such as, for example, queue type (e.g., high-risk, medium risk, legit check items, etc. via control 803), the time length from when the item was first queued (e.g., via control 804), a publication status (e.g., via control 805), keyword input (e.g., via control 806), category of the item, condition of the item, or the market from which the item originated, specific designers associated with the experts' expertise, particular designers, among other parameters using one or more interface controls. In this way, an expert may quickly locate items in the queue to be worked, and the review process becomes more timely and accurate as a result. Once reviewed, the item (e.g., item 807) may be published to the ecommerce system via one or more interface controls.

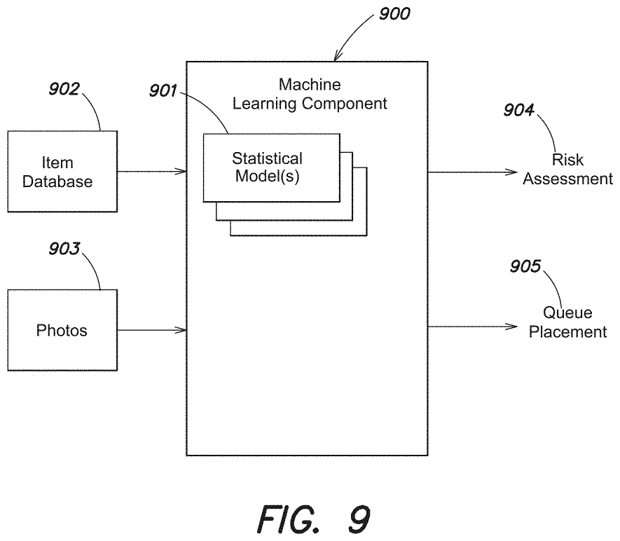

As discussed above, one or more machine learning elements may be used to assist managing users to process submitted items. For instance, as shown is FIG. 9, a machine learning component (e.g., component 900) may be used to assist in processing submitted items according to various embodiments. In some embodiments, the system may include one or more statistical models (e.g., statistical models 901) that are capable of being trained on one or more submitted items to the ecommerce system. The machine learning component may be used to assist in classifying and routing items to certain reviewers. In some cases, the machine learning component may be capable of determining a risk assessment for certain items and/or identifying issues with certain items that indicate that they may be counterfeit.

In some embodiments, machine learning component 900 is trained on one or more items from an item database (e.g., database 902). As discussed above, the system may maintain one or more databases of items. In some embodiments, the ecommerce system maintains multiple databases, and may use such databases for experts and/or assisting tools for classifying submitted items. For instance, the system may maintain a database of submitted items that have been identified as counterfeit. This item database may include information (e.g., photos (e.g., photos 903), description, item type, etc.) that may be used by an expert or one or more tools to compare to submitted item so that a verification status may be determined.

Machine learning component may be trained using one or more of these databases as sources, and one or more statistical models may be trained to perform certain tasks. In some embodiments, at least one of these statistical models may be trained to output a predicted risk assessment (e.g., assessment 904). This output risk assessment may be then displayed to a managing user within an interface for the purpose of assisting the managing user to review a submitted item. Further, the system may include a trained statistical component to actively place items in certain queues. In some embodiments, the statistical model may be executed in real time and move items among queues based upon real-time inputs. The system may assign a submitted item via an output indication of queue placement (e.g., placement 905) or any other output (e.g., a control output). In this manner, the processing of submitted items may be performed in a more efficient way, and in less time, requiring less user operations.

### CONCLUSION

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be understood that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be understood that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be understood that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A system comprising:
an interface component configured to receive a plurality of item listings from one or more users, each of the item listings corresponding to an item submitted by a respective user for sale in an electronic marketplace;
a queue of submitted items for sale;
a component that is adapted to assign at least one of the submitted items for sale to the queue of the submitted items for sale; and
a computer interface configured to permit an expert to view associated data submitted by the respective user for the item and to update a verification status of the item.

2. The system according to claim 1, wherein the expert is permitted to select the item submitted by the respective user from the queue of the submitted items for sale.

3. The system according to claim 2, wherein the system is configured to assign a review status of the item to the expert and remove the item from the queue.

4. The system according to claim 1, a component that is configured to determine a matching of at least one of the submitted items for sale to the expert.

5. The system according to claim 4, a component that is configured to determine a matching of the item to be verified with a second one of the plurality of experts, and conducting a second review of the item to be verified.

6. The system according to claim 1, further comprising a database of items that have been previously identified as being genuine.

7. The system according to claim 1, further comprising a database of items that have been previously identified as being counterfeit.

8. The system according to claim 1, wherein the computer interface further comprises a viewer configured to view images of item to be verified as being genuine with at least one of a plurality of experts.

9. The system according to claim 6, further comprising a component configured to determine, from a plurality of images of the item to be verified, a match score with a plurality of images associated with the database of items that have been previously identified as being genuine.

10. The system according to claim 7, further comprising a component configured to determine, from a plurality of images of the item to be verified, a match score with a plurality of images associated with the database of items that have been previously identified as being counterfeit.

11. The system according to claim 1, further comprising a component configured to determine a risk measure for the submitted item.

12. The system according to claim 11, wherein the risk measure is determined based on a designer identification of the submitted item.

13. The system according to claim 11, wherein the risk measure is determined based on a category of the submitted item.

14. The system according to claim 11, wherein the risk measure is determined based on user criteria of the respective user that submitted the item.

15. The system according to claim 11, wherein the risk measure is determined at least in part by a component configured to determine, from a plurality of images of the item to be verified, a verification status of the plurality of images with a plurality of images associated with the database of items that have been previously verified.

16. The system according to claim 15, wherein the verification status is at least one of a group comprising:
a status indication that the submitted item is genuine; and
a status indication that the submitted item is counterfeit.

17. The system according to claim 11, wherein the risk measure is a relative risk measure in relation to another item or groups of items.

18. The system according to claim 11, wherein the risk measure includes a risk score.

19. The system according to claim 14, wherein the user criteria includes information identifying a user that has previously submitted counterfeit items.

20. The system according to claim 19, wherein the user criteria includes information identifying a user is a trusted user.

21. The system according to claim 1, further comprising a user interface through which the respective user can submit a listing for the item for sale in the electronic marketplace.

22. The system according to claim 21, wherein the user interface includes at least one control to submit one or more photos of the item for sale.

23. The system according to claim 22, further comprising a component that determines, for a product category of the item, a set of photos required for the product category.

24. The system according to claim 1, further comprising a machine learning engine adapted to determine a risk measure for the item submitted by the respective user.

25. The system according to claim 24, wherein the machine learning engine is trained using at least one set of a group of data sets comprising:
a data set of items that have been previously identified as being genuine; and
a data set of items that have been previously identified as being counterfeit.

26. The system according to claim 24, wherein the machine learning engine is trained using at least one set of a group of data sets comprising a designer identification of the submitted item.

27. The system according to claim 24, wherein the machine learning engine is trained using at least one set of a group of data sets comprising a category of the submitted item.

28. The system according to claim 24, wherein the machine learning engine is trained using at least one set of a group of data sets comprising user criteria of the respective user that submitted the item.

29. The system according to claim 1, further comprising a data set of previously submitted items to which the submitted item is compared.

30. The system according to claim 29, wherein the data set of previously submitted items include a record of a previously-submitted item comprising a plurality of parameters and a set of one or more identifying images of the previously-submitted item.

31. The system according to claim 29, wherein the set of one or more identifying images of the previously submitted item comprises at least one of a group comprising:
a picture of a brand tag of the item;
a picture of a care tag of the item;
a picture of a Certilogo tag of the item; and
one or more pictures of the item from one or more perspectives.
